(19) United States
(12) Patent Application Publication
(10) Pub. No.: US 2017/0234298 A1
(43) Pub. Date: Aug. 17, 2017

(54) WIND CONCENTRATOR TURBINE GENERATOR

(71) Applicant: Douglas Andrew Robinson, Indianapolis, IN (US)

(72) Inventor: Douglas Andrew Robinson, Indianapolis, IN (US)

(21) Appl. No.: 15/412,413

(22) Filed: Jan. 23, 2017

Related U.S. Application Data
(60) Provisional application No. 62/386,180, filed on Nov. 23, 2015.

(51) Int. Cl. F03D 3/04; F03D 3/06; F03D 9/25

(52) U.S. Cl. CPC F03D 3/0427; F03D 9/25; F03D 3/065; F05B 2220/706; F05B 2240/13; F05B 2240/2212

(57) ABSTRACT

A wind concentrator turbine generator has an inlet cavity to concentrate a wind flow to a nozzle aperture. One or more turbine fans are oriented within a turbine cavity such that the concentrated find flow is directed at the turbine fans. A generator is coupled to each of the one or more turbine fans. The generator is scalable from discrete power generation requirements to utility scale power generation. Larger scale generators may be connected to deliver electrical power to regional electrical power grids.

### CROSS-REFERENCE TO RELATED APPLICATION

This application claims the benefit of priority of U.S. provisional application No. 62/386,180, filed Nov. 23, 2015, the contents of which are herein incorporated by reference.

### BACKGROUND OF THE INVENTION

The present invention relates to wind turbine power generators and, more particularly to wind turbine power generators with low cut-in velocities.

Current wind turbines capable of operating on a utility scale have a low capacity factor, which limits their effective utilization in low annual wind environments. Due to the size and weight of most turbine blades it takes a high cut in speed to start and turn them, meaning they don't rotate at all times and therefore do not harness energy unless the cut in wind velocity is achieved. Consequently, these systems limit the geographic locations where these wind turbines can affordably harness this inexhaustible form of green energy. While ocean or open water turbines may have output ratings of 3.6 MW, land based turbines presently have a maximum annual output rating of only about 2.5 MW. Current utility scale wind turbines aren't able to be utilized in low annual wind areas. In addition, their energy output is minimal compared to offshore turbines.

As can be seen, there is a need for an improved wind turbine generator with significantly reduced cut in speeds, making it possible to be deployed in low annual wind areas.

### SUMMARY OF THE INVENTION

In one aspect of the present invention, a wind turbine generator includes a wind concentrator, a turbine cavity, a turbine fan rotationally disposed within the turbine cavity, and an electrical generator. The wind concentrator has an inlet cavity defined between a converging interior sidewall of a left and a right side panel, the inlet cavity terminating at a nozzle aperture. An exit cavity is defined by a diverging interior sidewall of the left and the right side panel. The turbine cavity is defined in the interior sidewall and in fluid communication with the nozzle aperture. The turbine has a plurality of elongate blades radially disposed about a hub. A leading side of the turbine fan is positioned to capture a concentrated air flow exiting the nozzle aperture. The electrical generator operatively coupled to the hub.

In preferred embodiments, the wind turbine generator includes a central spire formed as a symmetrical airfoil that is interposed between the left and the right side panel, such that the turbine aperture is defined between an outwardly diverging sidewall of the spire and the converging interior sidewall. A depression may be formed in the spire aft of the nozzle aperture, with the depression forming a portion of the turbine cavity.

In other embodiments, the wind concentrator also includes an exit cavity defined aft of the nozzle aperture between diverging interior sidewalls of a wing extension of the left and the right side panel and a converging sidewall of the spire.

In yet other embodiments, a plurality of turbine fans are axially aligned within the turbine cavity. Each of the plurality of turbine fans may be operatively coupled to one of a plurality of electrical generators.

The spire and the left and the right side panels may be formed from at least one longitudinally extending spar with a plurality of support members operatively coupled to the spar to define a skeletal support frame. An outer skin surface is applied to cover the skeletal support frame.

In other aspects of the invention, the wind turbine generator may be mounted to a base configured to rotationally support the wind turbine generator and orient the inlet cavity into a wind source. The base may be powered to rotate the wind turbine generator.

In some embodiments, an outer sidewall of the left and the right side panel converge inwardly from a leading tip of the left and the right side panel to a point aft of the nozzle aperture.

In other aspects of the invention a wind concentrator has a spire formed as a symmetrical airfoil interposed between a left and a right side panel. An inlet cavity is defined between a converging interior sidewall of the left and the right side panel and a diverging sidewall of the spire. The inlet cavity terminates at a nozzle aperture. A turbine cavity is partially defined by the interior sidewall and is in fluid communication with the nozzle aperture. An exit cavity is defined by a diverging interior sidewall of a wing extension of the left and the right side panel.

In other aspects of the invention, a turbine fan is rotationally disposed within the turbine cavity. The turbine fan has a plurality of elongate blades radially disposed about a hub, wherein a leading side of the turbine fan is positioned to capture a concentrated air flow exiting the nozzle aperture.

In some embodiments of the apparatus, an electrical generator is operatively coupled for rotation with the turbine fan. In other embodiments, a plurality of turbine fans are axially aligned within the turbine cavity. Preferably, an electrical generator is operatively coupled to each of the plurality of turbine fans.

The apparatus may also include a base configured to rotationally support the wind concentrator and orient the inlet cavity into a wind source. Preferably, the base is powered.

In other embodiments, an outer sidewall of the left and the right side panel converge inwardly from a leading tip of the left and the right side panel to a point aft of the nozzle aperture.

These and other features, aspects and advantages of the present invention will become better understood with reference to the following drawings, description and claims.

### BRIEF DESCRIPTION OF THE DRAWINGS

FIG. 1 is a perspective view of an embodiment of a wind concentrator turbine generator according to aspects of the present invention;

FIG. 2 is a perspective cutaway view of the wind concentrator turbine generator;

FIG. 3 is a rear elevation view of the wind concentrator turbine generator;

FIG. 4 is a front elevation view of the wind concentrator turbine generator;

FIG. 5 is a perspective view of an embodiment of a generator component; and

FIG. 6 is a section plan view of the wind concentrator turbine generator taken along line 6-6 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved wind turbine generator that may be utilized to harness wind energy, particularly in locations with light wind conditions. The wind concentrator wind turbine generator may be scaled to meet a broad range of power generation requirements, from site specific low power requirements to large utility scale requirements. At larger capacities, the wind concentrator wind turbine generator may be connected to contribute generated electrical power into regional power grids.

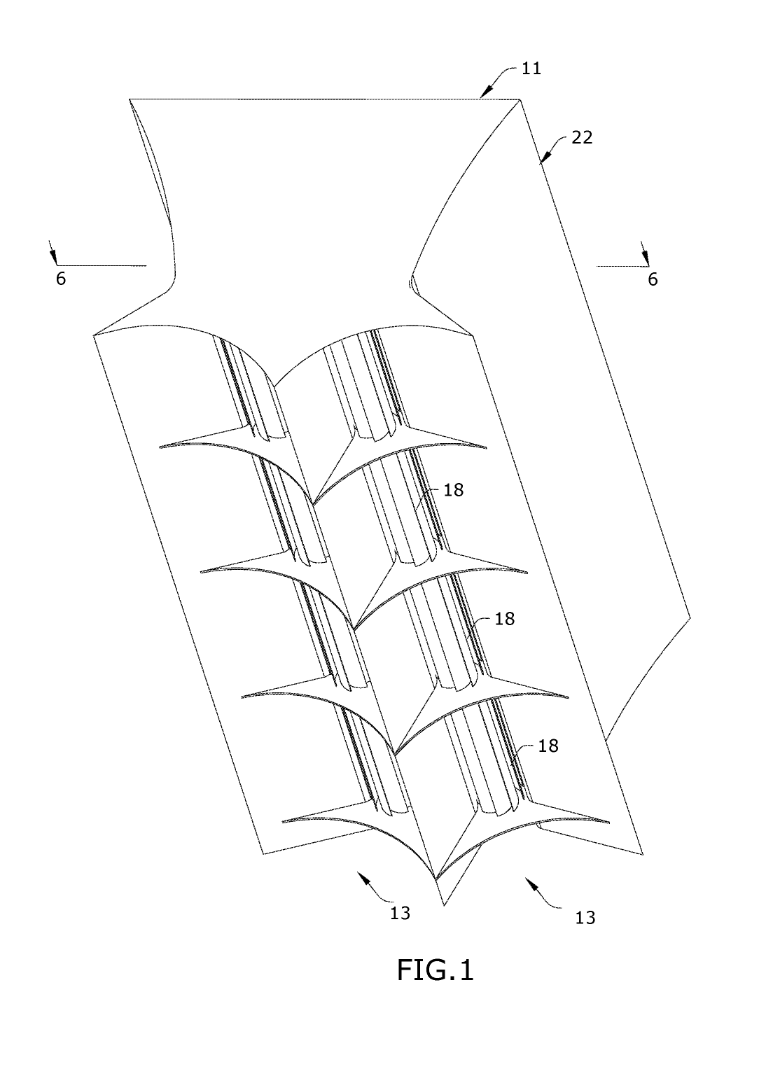

As seen in reference to FIGS. 1, 2, and 6 an embodiment of a wind concentrator turbine generator of the present invention is shown with a wind concentrator structure 22 mounted to rotate about a vertical axis of rotation. The wind concentrator turbine generator may be carried on a rotating base support that provides for orientation of an inlet of the concentrator structure 22 to align with and capture a wind flow 24. For large utility applications of the wind concentrator turbine generator, the rotating base support may be a powered turn style.

The concentrator 22 has a central spire 12 and a left and a right side panel 10 disposed on either side of the central spire 12. The central spire 12 is formed as a substantially symmetrical airfoil. A chord line of the airfoil is oriented substantially perpendicular to the axis of rotation and extends between an inlet end 11 of the concentrator 22 and an outlet end 13 of the concentrator 22.

The left and right side panels 10 are preferably mirror images of each other and have opposed inwardly converging interior sidewalls 15 to define a slotted nozzle aperture 16 on either side of the central spire 12 at an aft portion thereof. A vertically oriented turbine cavity 17, or turbine shaft, is defined distal to and in fluid communication with the nozzle aperture 16 by arcuate depressions in the interior sidewalls of the left and right side panels 10 and the exterior sidewalls of the spire 12. The turbine cavity 17 has a longitudinal axis that is substantially parallel to the longitudinal vertical axis of the concentrator 22.

A turbine fan 18 is received within the turbine cavity 17 such that a forward end of the interior sidewalls of the turbine cavity 17 substantially surround the a forward end of the turbine fan 18. The turbine fan is preferably of a Pelton type, having a plurality of radially emanating blades extending from a hub portion of the turbine fan 18 in a spaced apart relation around the circumference of the hub portion. The radially emanating blades may be further elongated and have a curvature opposite the axis of rotation of the turbine fan 18 to provide an increased surface area to capture sufficient mass air flow and velocity from the concentrated wind 24 exiting the nozzle. The left and the right turbine fan 18 are preferably oriented in a counter rotating orientation relative to each other.

The turbine fan 18 has an axis of rotation about the hub that is offset from the nozzle aperture 16 such that the blades at a leading side of the turbine fan 18 or oriented to capture the fluid flow 24 exiting the nozzle 16. The fan blades are spaced about the hub such that as the turbine fan 18 rotates, the nozzle aperture 16 is continuously presented with a blade to capture the exiting airflow 24 between the blade and the turbine cavity 17 sidewall.

An aft end of the turbine cavity 17 opens to the exit cavity 13 at the outlet, which is configured as a diverging nozzle assembly to reduce backflow of free flowing air behind the turbine fan 18. The diverging nozzle of the exit cavity 13 is defined between the converging sidewalls at the aft end of the spire 12 and an aft wing extension oriented laterally outwardly and rearward at an aft end of the turbine cavity portion 17 of the left and right side panels 10. The wing extensions 19 are oriented and configured improve airflow velocity through the concentrator 22.

To improve airflow through the concentrator 22, the outwardly facing sidewalls of the left and right side panels 10 converge inwardly from a leading tip of the panels 10 to a point proximal to a center axis of the turbine cavities 17. The outwardly facing sidewalls then extend laterally and rearward to with the diverging sidewalls the exit cavity 13.

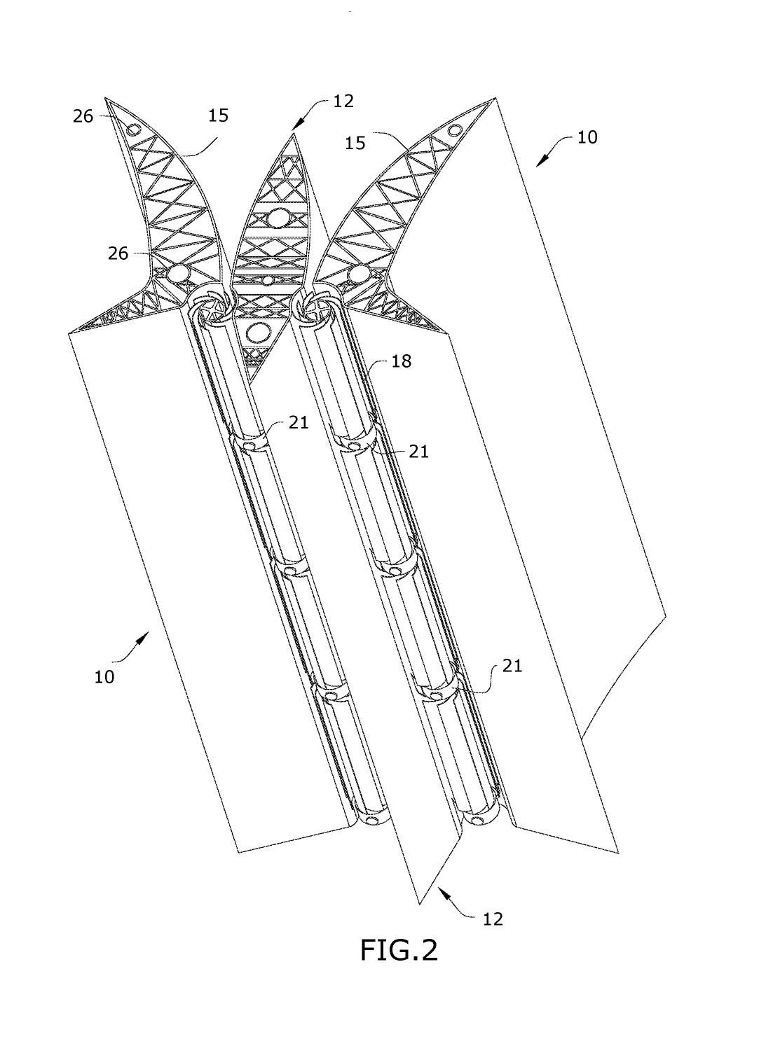

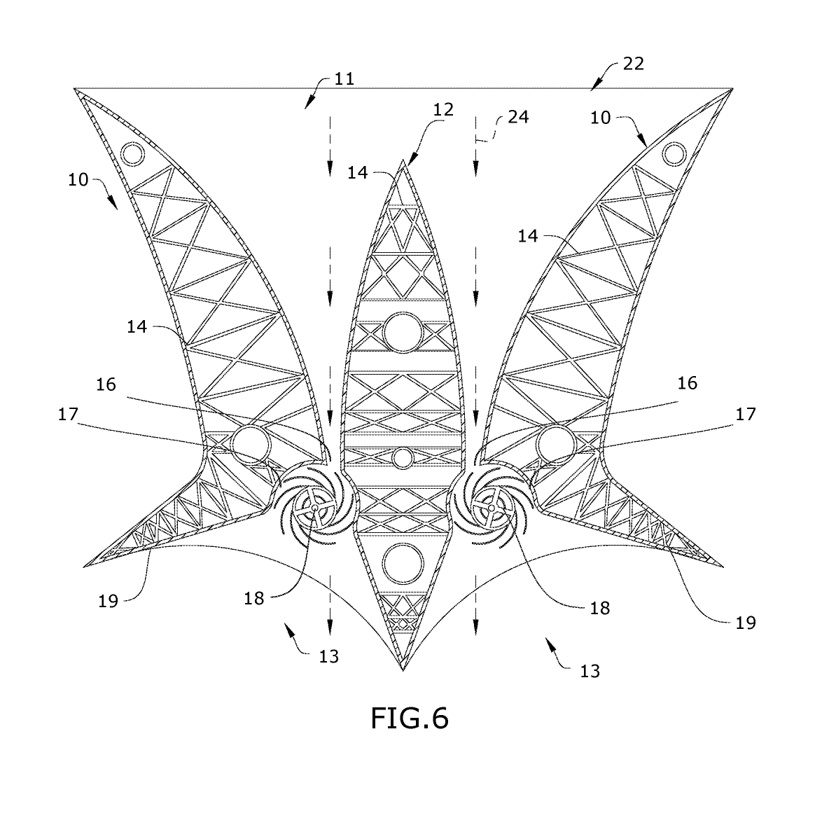

As seen in reference to FIGS. 2 and 6, the spire 12 and side panels 10 are formed like conventional airfoil structures having one or more internal spars 19 extending along a longitudinal length of the respective structures. An internal skeletal structure is formed from a plurality of interconnected support members 14, coupled to the one or more internal spars 19. An outer surface, or skin, is applied to the skeletal frame to define the air flow surfaces of the concentrator 22.

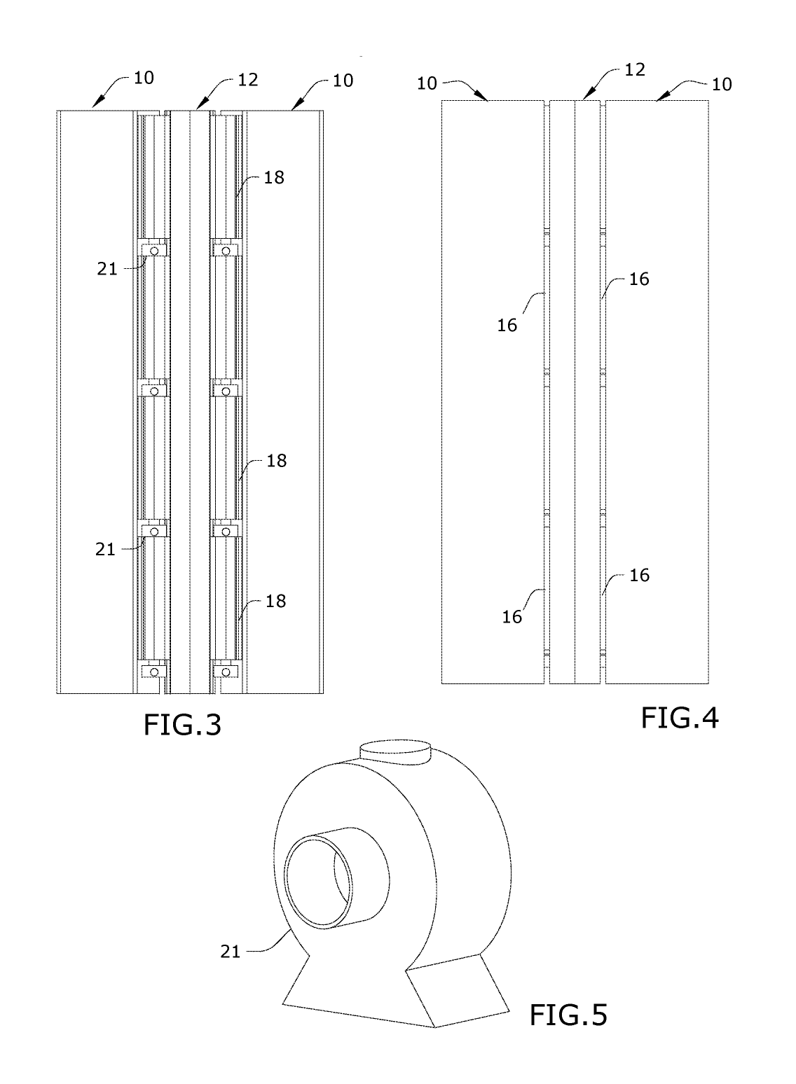

As best seen in reference to FIGS. 2 and 3, the wind concentrator turbine generator may be configured with a plurality of turbine fans 18 that are received in series within the turbine cavity 17. Each turbine fan 18 has an associated generator 21 coupled at a first end of the turbine fan 18 and an associated bearing at a second end of the turbine fan 18 such that each of the plurality of turbine fans 18 are free to rotate at a speed commensurate with the concentrated airflow 24 at a various elevations of the concentrator 22. The independent rotation of each turbine fan 18 accommodates for variations in airflow velocity profile relative to the height above the ground surface, which generally increases in velocity with altitude. Similarly, the reduced size of the associated generator 21 contributes to the achievement of a low cut in velocity for producing wind power generation in low wind environments and geographic locations. It will be appreciated that while each of the turbine fans 18 are illustrated as having the same length, the length of the fans 18 may be varied according to a prevailing elevation velocity profile typically encountered at a selected site for employment of the wind concentrator turbine generator.

As seen in reference to FIG. 4, the converging inlet of the concentrator 22 presents a frontal surface area spanning the width and height of the concentrator 22. Wind flow 24 is concentrated between the converging sidewalls of left and right side panels 10 and the diverging sidewalls of the center spire 12 to concentrate the wind flow 24 at the slotted nozzle apertures 16 on either side of the center spire 12.

As seen in reference to FIG. 3, the diverging outlet of the concentrator 22 presents an exit surface area between diverging sidewalls to the tips of the wing extensions 19 and the converging sidewalls of the spire 12 aft of the nozzle slot 16.

As stated previously, the wind concentrator turbine generator may be scaled to any size to accommodate various power generation requirements. By way of non-limiting example, a representative utility scale version of the wind concentrator turbine generator may have a height of on the order of 400 ft. The outer panels 10 may be formed to have a span of 130 ft. between the leading tips of the panels 10 and a depth of 107 ft. between the leading tips of the panels 10 and the tips of the wing extensions 19. The nozzle aperture slot may be configured to have an opening of about 3 ft. The turbine fan 18 may be configured to have a radius of 8½ ft.

In Fluent Analysis modeling, this configuration has achieved a factor of velocity increase (FVI) of 3.93 and with an initial wind velocity of 20 m/s (44.74 mph) achieving a final concentrated wind velocity at the nozzle aperture 16 of 78.9 m/s (176.49 mph). ANSYS modeling also indicates that with an input wind speed of 16 mph, the viable output of a generator 21 is between about 480-500 kW per generator 21. When configured with 8 generators 16, the system has a theoretical output of 4 MW. When compared to typical wind turbine generators in the art, which have a watts per dollar (W/$) of installed capacity that range from 0.5-0.667 W/$, a wind concentrator turbine generator of the present invention can achieve 1.097 W/$.

It should be understood, of course, that the foregoing relates to exemplary embodiments of the invention and that modifications may be made without departing from the spirit and scope of the invention as set forth in the following claims.

What is claimed is:

1. A wind turbine generator comprising:
a wind concentrator having an inlet cavity defined between a converging interior sidewall of a left and a right side panel, the inlet cavity terminating at a nozzle aperture, and a exit cavity defined by a diverging interior sidewall of the left and the right side panel;
a turbine cavity defined in the interior sidewall in fluid communication with the nozzle aperture;
a turbine fan rotationally disposed within the turbine cavity, the turbine having a plurality of elongate blades radially disposed about a hub, wherein a leading side of the turbine fan is positioned to capture a concentrated air flow exiting the nozzle aperture; and
an electrical generator operatively coupled to the hub.

2. The wind turbine generator of claim 1, further comprising:
a central spire formed as a symmetrical airfoil interposed between the left and the right side panel, wherein the turbine aperture is defined between an outwardly diverging sidewall of the spire and the converging interior sidewall.

3. The wind turbine generator of claim 2, further comprising:
a depression formed in the spire aft of the nozzle aperture, the depression forming a portion of the turbine cavity.

4. The wind turbine generator of claim 2, wherein the wind concentrator further comprises:
an exit cavity defined aft of the nozzle aperture between diverging interior sidewalls of a wing extension of the left and the right side panel and a converging sidewall of the spire.

5. The wind turbine generator of claim 4, further comprising:
a plurality of turbine fans axially aligned within the turbine cavity.

6. The wind turbine generator of claim 5, wherein each of the plurality of turbine fans is operatively coupled to one of a plurality of electrical generators.

7. The wind turbine generator of claim 2, wherein the spire and the left and the right panels further comprise:
at least one longitudinally extending spar;
a plurality of support members operatively coupled to the spar to define a skeletal support frame; and
an outer skin surface covering the skeletal support frame.

8. The wind turbine generator of claim 2, further comprising:
a base configured to rotationally support the wind turbine generator and orient the inlet cavity into a wind source.

9. The wind turbine generator of claim 8, wherein the base is powered.

10. The wind turbine generator of claim 2, further comprising:
an outer sidewall of the left and the right side panel converging inwardly from a leading tip of the left and the right side panel to a point aft of the nozzle aperture.

11. An apparatus comprising:
a wind concentrator comprising:
a spire formed as a symmetrical airfoil interposed between a left and a right side panel,
an inlet cavity defined between a converging interior sidewall of the left and the right side panel and a diverging sidewall of the spire, the inlet cavity terminating at a nozzle aperture,
a turbine cavity partially defined by the interior sidewall and in fluid communication with the nozzle aperture; and
an exit cavity defined by a diverging interior sidewall of a wing extension of the left and the right side panel.

12. The apparatus of claim 11, further comprising:
a turbine fan rotationally disposed within the turbine cavity, the turbine fan having a plurality of elongate blades radially disposed about a hub, wherein a leading side of the turbine fan is positioned to capture a concentrated air flow exiting the nozzle aperture.

13. The apparatus of claim 12, further comprising:
an electrical generator operatively coupled for rotation with the turbine fan.

14. The apparatus of claim 13, further comprising:
a plurality of turbine fans axially aligned within the turbine cavity.

15. The apparatus of claim 14, further comprising:
an electrical generator operatively coupled to each of the plurality of turbine fans.

16. The apparatus of claim 11, further comprising:
a base configured to rotationally support the wind concentrator and orient the inlet cavity into a wind source.

17. The apparatus of claim 16, wherein the base is powered.

18. The apparatus of claim 11, further comprising:
an outer sidewall of the left and the right side panel converge inwardly from a leading tip of the left and the right side panel to a point aft of the nozzle aperture.
